(19) United States
(12) Patent Application Publication
(10) Pub. No.: US 2019/0344995 A1
(43) Pub. Date: Nov. 14, 2019

(54) ELEVATOR INSTALLATION WITH PREDICTIVE CALL BASED ON NOISE ANALYSIS

(71) Applicant: INVENTIO AG, Hergiswil (CH)

(72) Inventor: Edward NOWEL, Columbia, NJ (US)

(21) Appl. No.: 16/466,884

(22) PCT Filed: Dec. 4, 2017
(86) PCT No.: PCT/EP2017/081405

§ 371 Date: Jun. 5, 2019

(30) Foreign Application Priority Data
Dec. 6, 2016 (EP) 16202343.6

(51) Int. Cl. B66B 1/24; B66B 1/34; B66B 1/46; B66B 1/28; G01H 3/06

(52) U.S. Cl. CPC B66B 1/2416; B66B 1/3461; B66B 1/468; B66B 2201/402; G01H 3/06; B66B 2201/4638; B66B 2201/401; B66B 1/28

(57) ABSTRACT

An elevator installation for a building includes an elevator controller to move from one floor to another floor and a plurality of sensor units. Each sensor unit is located on a floor and configured to generate an electrical signal that is indicative of a noise level in its vicinity. A processing unit analyzes received electrical signals to determine if there is an increased noise level on a floor on which the sensor unit generating that electrical signal is located, and to detect that a source of noise moves to distinguish it from a non-moving source of noise that may also be responsible for an increased noise level, and generates a control signal for the elevator controller that is indicative of the floor with the increased noise level. The elevator controller in response to the control signal causes the elevator car to move to the floor with the increased noise level.

### CROSS-REFERENCE TO RELATED APPLICATIONS

This application is the national phase application under 35 U.S.C. § 371 claiming the benefit of priority based on International Patent Application No. PCT/EP2017/081405, filed on Dec. 4, 2017, which claims the benefit of priority based on European Patent Application No. 16202343.6, filed on Dec. 6, 2016. The contents of each of these applications are herein incorporated by reference.

### FIELD OF THE INVENTION

The present disclosure of various embodiments generally relates to control schemes applied in elevator installations. More particularly, the various embodiments described herein relate to scheduling elevator trips.

### BACKGROUND OF THE INVENTION

An elevator installation typically applies one of two distinct control schemes, namely a conventional up/down control system (i.e., a passenger enters a destination floor via a car operating panel (COP) from within an elevator car), or a destination call control system (i.e., a passenger enters a destination floor via a landing operating panel (LOP) while at a boarding floor). In either one of these systems, it is an objective to optimize the transportation efficiency, e.g., to reduce passengers' waiting time. For example, U.S. 2016/0130112 A1 discloses the scheduling of elevator cars using uncertain information about arrival times of future passengers at any floor of a building. The scheduling considers arrival information acquired by sensors (motion detectors, surveillance cameras, or proximity sensors), and the probability of service requests by the future passengers and the probability of possible times of the service. Similarly, a scheduling technology disclosed in WO 2006/113598 uses advanced traffic information to improve performance for passengers. The information is obtained from a destination entry system having a keypad located at a distance from the elevators, sensors in a corridor leading to the landing, video cameras, identification card readers, and computer systems networked to a group elevator control to provide advanced reservations or requests for cars to specific destination floors based upon predicted demand, such as a hotel conference schedule system providing information as to when meetings will start or end and therefore generate a demand for elevator service.

These technologies strive to improve the overall scheduling process. Accordingly, the disclosed technologies apply rather complex models and procedures. Not all buildings, however, require elevator installations operating in accordance with such complex scheduling processes. There is, therefore, a need for an alternative technology that is more suitable for such buildings.

### SUMMARY OF THE INVENTION

Accordingly, one aspect of such a technology involves an elevator installation for a building having a plurality of floors. The elevator installation includes an elevator controller to control an elevator car to move from one floor to another floor, a plurality of sensor units, and a processing unit coupled to the elevator controller and the sensor units. Each sensor unit is located on a floor and configured to generate an electrical signal that is indicative of a noise level in its vicinity on the floor. The processing unit is configured to analyze received electrical signals to determine if an electrical signal indicates an increased noise level on a floor on which the sensor unit generating that electrical signal is located, and to generate a control signal for the elevator controller that is indicative of the floor with the increased noise level. Analyzing an electrical signal includes analyzing a frequency shift caused by the Doppler effect to determine if a source of noise approaches the respective sensor unit, or determining a sequence of sensor units that sequentially detect increased noise levels on a floor to determine a direction of movement of the source of noise. In response to the control signal, the elevator controller is configured to cause the elevator car to move to the floor with the increased noise level.

Another aspect of the technology involves a method of controlling an elevator installation in a building having a plurality of floors. The elevator installation includes an elevator controller that causes an elevator car to move from one floor to another floor, a plurality of sensor units located on the floors, and a processing unit coupled to the elevator controller and the sensor units. According to the method, electrical signals from the sensor units are received by the processing unit, wherein each electrical signal is indicative of a noise level on a floor in a vicinity of the sensor unit that generates the electrical signal. The electrical signals are analyzed by the processing unit to determine if one of the electrical signals is indicative of an increased noise level on the floor on which the sensor unit generating that electrical signal is located. Analyzing an electrical signal includes analyzing a frequency shift caused by the Doppler effect to determine if a source of noise approaches the respective sensor unit, or determining a sequence of sensor units that sequentially detect increased noise levels on a floor to determine a direction of movement of the source of noise. If such an electrical signal is determined, a control signal for the elevator controller is generated by the processing unit that is indicative of the floor with the increased noise level. In response to the control signal, the elevator car is caused by the elevator controller to move to the floor with the increased noise level.

The technology described herein uses sensor units to detect if noise on a floor increases. Noise may increase on a floor, for example, when the door of a meeting or conference room opens and people outpour from the room onto the hallway chatting or making other noises. The technology analyzes the noise to detect that a source of noise moves to distinguish it from a non-moving source of noise that may also be responsible for an increased noise level. A generated electrical signal is analyzed to determine a frequency shift caused by the Doppler effect, or generated electrical signals are analyzed to determine a sequence of sensor units that sequentially detect increased noise levels on a floor to determine a direction of movement of the source of noise. The technology interprets this as a need for elevator service on that floor, and sends one or more elevator cars to that floor in anticipation that a call will be entered on that floor. Hence, when the first people reach the elevator, an elevator car may already be there waiting, be on the way to that floor, or be scheduled to move to that floor. This reduces the waiting time and improves the overall car scheduling of the elevator installation.

In one embodiment, each sensor unit includes an electroacoustic transducer. The electroacoustic transducer converts air pressure changes caused by noise or voices into the electrical signal; it may be a microphone. Such electroacoustic transducers have a relatively small form factor and low complexity, and are readily available, also at low cost.

The improved technology provides flexibility regarding implementation of the sensor units. This allows adapting the technology to particular requirements and circumstances of a particular building. In one embodiment, each sensor unit includes a radio frequency (RF) module for wirelessly transmitting the electrical signal. In another embodiment, the elevator installation includes a communications network having communications lines, and each sensor unit is coupled to the processing unit via at least one of the communications lines.

To receive such wirelessly transmitted electrical signals, the elevator installation includes in one embodiment a plurality of radio frequency (RF) transceivers coupled to the processing unit. Each RF transceiver is configured to receive the electrical signal transmitted by the sensor unit's RF module that is located within radio frequency range. Using wireless transmission technology simplifies installing the sensor units, and, as no wires or cables need to be installed, provides flexibility regarding selecting the locations of the sensor units.

In one embodiment, the RF transceivers may be comprised in floor terminals that further include floor call terminals of the elevator installation. This allows running the cables that may be needed to couple the RF transceivers to the processing unit together, e.g., in the same conduit, with those needed to couple the floor call terminals to the elevator controller. This simplifies the installation, e.g., with respect to time and cost, and may be an advantage if design aspects need to be considered, e.g., one design aspect may require that the RF transceivers are not visible. The possibility of using the same conduit may be beneficial when a building owner decides to upgrade or modernize the building with the technology described herein, e.g., to adapt the elevator installation to changed circumstances (e.g., higher passenger traffic due to, e.g., changed used of the building). During such an upgrade project, cables can be installed in the existing elevator shaft, and the wireless sensor units can be installed at desired locations without having to install cables. The RF transceivers that receive the electrical signals from the sensor units may be installed at convenient locations and coupled, e.g., to the vertically running cables in the elevator shaft.

Further, the technology may be modified by using not only noise analysis, but additionally building related information. In one embodiment, the elevator installation includes a database coupled to the processing unit, and storing data relating to building events. Such events include, for example, dates for conferences, arrivals of groups, or building constructions. The data can be used by the processing unit to refine the scheduling of an elevator car.

With or without the refinement option through using the building event data, the technology provides choices regarding the determination of whether or not noise level increased on a floor. Selecting one of these choices allows choosing between a more or less complex implementation. In one embodiment that allows a less complex implementation, when determining if one of the electrical signals is indicative of an increased noise level, the noise level represented by an electrical signal is compared with a threshold value. If the noise level exceeds the threshold value, this indicates an increased noise level of the respective floor. The threshold value represents in one embodiment a base noise level prevailing on a floor. To adapt for various situations in a building, e.g., during a 24-hour day, the base noise level is a function of time. In another embodiment, the threshold value represents an average noise level caused by talking persons. That noise level may be fixed for each floor, or determined by a measurement on each floor. The measurements take into account acoustic situations on the floor.

In one embodiment, the control signal for the elevator controller is generated when a predetermined period of time expires. This time period delays the generation of the control signal to avoid that a transient or impulse noise triggers the sending of an elevator car to the floor.

### BRIEF DESCRIPTION OF THE DRAWINGS

The novel features and method steps characteristic of the technology are set out in the claims below. The various embodiments of the technology, however, as well as other features and advantages thereof, are best understood by reference to the detailed description, which follows, when read in conjunction with the accompanying drawings, wherein:

FIG. 1 shows a schematic illustration of an exemplary building equipped with one embodiment of an elevator installation applying elevator car scheduling based on sound analysis;

FIG. 2 shows a schematic illustration of an exemplary situation of a floor of the building shown in FIG. 1;

FIG. 3 shows a schematic illustration of one embodiment of a processing unit performing sound analysis and scheduling processing; and

FIG. 4 is a flow diagram of one embodiment of a method of operating the elevator installation of FIG. 1.

### DETAILED DESCRIPTION OF EMBODIMENTS OF THE INVENTION

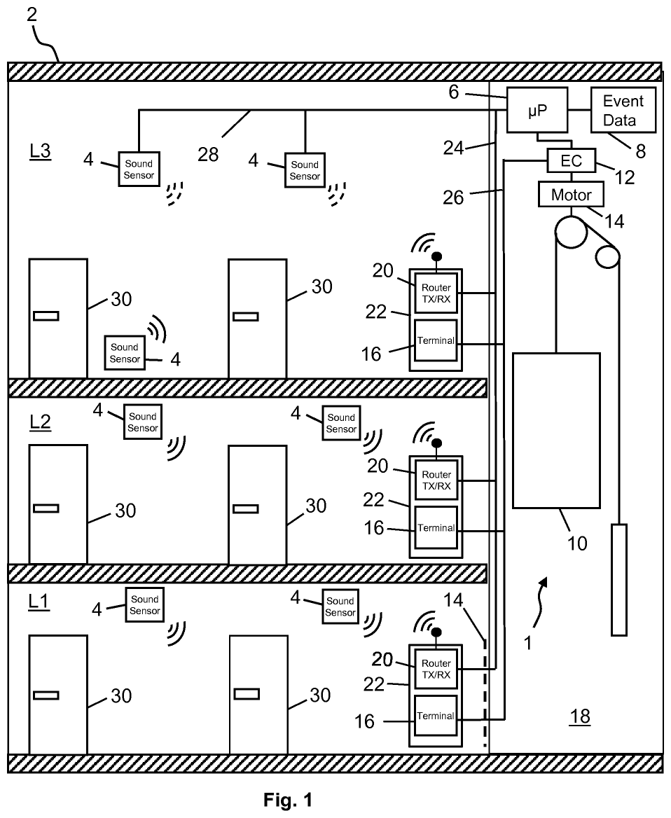

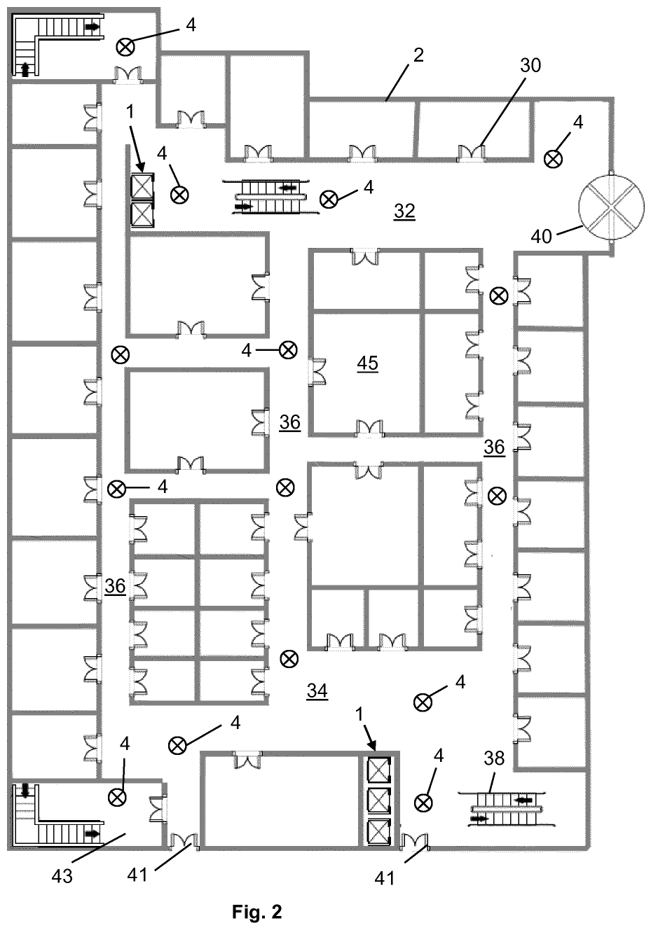

FIG. 1 is a schematic illustration of one embodiment of a building 2 equipped with one embodiment of an elevator installation 1 that applies elevator car scheduling based on sound analysis. The building 2 may be an apartment building, an office building, a commercial/shopping center, a conference center, a hotel, a sports arena, an airport terminal, a ship, or any other structure suitable for a person to reside or stay for a certain period of time. The exemplary building 2 shown in FIG. 1 is used herein to describe various embodiments of the technology; it is contemplated, however, that other structures may have a different layout. The illustrated part of the building 2 has several floors L1, L2, L3, each one providing access to dedicated areas or zones (e.g., offices or apartments) and an elevator car 10 of the elevator installation 1. That is, a passenger can board the elevator car 10 on one of these floors L1, L2, L3 (sometimes referred to as a boarding floor), and, after having been transported to another one of these floors L1, L2, L3 (sometimes referred to as a destination floor), exit the elevator car 10 at the destination floor. On at least one of the floors L1, L2, L3, the passenger may enter an office, an apartment, a restaurant, a conference room, a ball room, or exit the building 2 via a door 30, e.g., an apartment/office door or a building door. It is contemplated that the elevator installation 1 may have more than one elevator car, e.g., in an elevator group, and that the building 2 may have more than one elevator installation 1, as exemplary shown in FIG. 2.

FIG. 1 shows components of the elevator installation 1 to the extent believed to be helpful for a complete understanding of the technology described herein. An elevator controller 12 (EC) is coupled to a drive system 14 (Motor), which is configured to move the elevator car 10 by means of one or more suspension members up and down a shaft 18. As an alternative to such a traction elevator, in another embodiment, the elevator installation 1 may be a hydraulic elevator. The elevator controller 12 includes in one embodiment a call control unit, which processes calls received from floor call terminals 16, a car terminal (not shown), or both. The call processing depends on the implemented control scheme (e.g., a conventional up/down control system or a destination call control system), and includes, for example, determining the floor L1, L2, L3 where the elevator car 10 is needed, determining the destination floor L1, L2, L3, and acknowledging the call. Based on that call processing, the elevator controller 12 controls the drive system 14 to move the elevator car 10 to the boarding floor L1, L2, L3, and then to the destination floor L1, L2, L3. Depending on a particular embodiment, the functionality of the call control unit may be implemented separate from the elevator controller 12, e.g., in a separate control unit coupled to the elevator controller 12.

The elevator installation 1 includes further a plurality of sensor units 4 arranged at predetermined locations, e.g., inside the building 2 and/or within a predetermined area outside the building 2. In one embodiment, the sensor unit 4 includes an electroacoustic transducer that converts air pressure changes caused by noise, sound and/or voices (hereinafter, noise is used to refer to one or more of these causes for air pressure changes) into an electrical signal output from the sensor unit 4. Hereinafter, the electrical signal is referred to as audio signal. The electroacoustic transducer may be referred to herein as acoustic sensor. One example of such a transducer or sensor is a microphone. The audio signal is a function of time and the volume/loudness of the noise, sound, and/or voices.

Depending on a particular configuration of the sensor unit 4, the audio signal output by the sensor unit 4 may be an analog signal or a digital signal (i.e., the sensor unit 4 itself converts electrical signal generated by the electroacoustic transducer into a digital signal). Hereinafter, the audio signal is a digital signal, its particular format depending on which digital signal formatting is used. For example, the digital signal may be a pulse train (e.g., a pulse amplitude modulated signal) that is a sequence of fixed-width square-wave electrical pulses, each occupying a discrete number of levels of amplitude, wherein, e.g., a binary signal varies between a low and a high signal level. The digital signal may be a representation of an electrical signal that is sampled and quantified; resulting quantities are represented as a sequence of codes, and, e.g., transmitted as a pulse code modulation (PCM) signal.

It is contemplated that the sensor units 4 can have different configurations regarding their operation. For example, the sensor units 4 may be always on once installed and powered; or they may be activated and deactivated as needed. For instance, in one embodiment, the sensor units 4 may be selectively activated and deactivated, e.g., floor-by-floor. In one embodiment, the sensor units 4 are activated when the elevator installation 1 is in operation (as opposed to being out of service during maintenance). An always on, or activated sensor unit 4 constantly detects the noise level in its vicinity, and, accordingly, generates a continuous audio signal that changes over time depending on the noise level.

The sensor units 4 are coupled to a processing unit 6 (μP), which is coupled to the elevator controller 12 and a building event database 8. The processing unit 6 may be integrated into the elevator controller 12, or arranged at a central location within the building 2, e.g., as a stand-alone device, or in connection with a building management system. By coupling the sensor units 4 to the processing unit 6, generated audio signals are communicated to the processing unit 6 for further processing and analysis. The coupling may be achieved according to one or more technologies. For illustrative purposes, some of these technologies (wired and wireless) are illustrated in FIG. 1. It is contemplated, however, that in certain embodiments only one of these technologies is used.

In one embodiment, a communications network having communications lines 28 couple each sensor unit 4 to the processing unit 6, as indicated by two sensor units 4 on floor L3. The illustrated communications line 28 may be based on individual wires (or cables) that establish point-to-point connections between the sensor units 4 and the processing unit 6, or a communications bus structure, wherein the sensor units 4 and the processing unit 6 are coupled to the communications bus. In the alternative, as also shown in the embodiment of FIG. 1, the sensor units 4 are configured for wireless communications with the processing unit 6. Each sensor unit 4 includes a radio frequency (RF) module that transmits RF signals according to a certain RF communications technology, such as WiFi/WLAN. To receive these RF signals, FIG. 1 shows RF transceivers 20 (Router TX/RX) installed on each floor L1, L2, L3 and coupled to the processing unit 6 via a communications line 24. The communications line 24 may be based on individual wires (or cables) that establish point-to-point connections between the RF transceivers 20 and the processing unit 6, or a communications bus structure, wherein the RF transceivers 20 and the alarm processing unit 6 are coupled to the communications bus. The RF transceivers 20 may be identified by the processing unit 6 through its address if a bus structure is used, or through a port at which the RF transceiver 20 is connected to the processing unit 6.

Although FIG. 1 shows one RF transceiver 20 for each floor L1, L2, L3, it is contemplated that two or more RF transceivers 20 may be installed on a floor L1, L2, L3. The number of RF transceivers 20 may depend on parameters such as the layout or size of the floor L1, L2, L3, the maximum distance between the RF transceiver 20 and the sensor units 4, and the used RF technology. In consideration of one or more of these parameters, each location for the RF transceiver 20 is selected to be within radio frequency range of a respective sensor unit 4 so that reliable RF communications is ensured.

In the embodiment shown in FIG. 1, the RF transceiver 20 is part of a floor terminal 22 that also houses the floor call terminal 16 of the elevator installation 1. Alternatively, each RF transceiver 20 may be a stand-alone device mounted at a location on the floor L1, L2, L3 independent of the floor call terminal 16. In each floor terminal 22 of the illustrated embodiment, the floor call terminal 16 is coupled via an elevator control network 26 to the elevator controller 12, and the RF transceiver 20 is coupled to the processing unit 6 via a communications line 24. The floor terminal 22 may have a column-like structure for mounting on the floor at a convenient location for elevator passengers. Alternatively, the floor terminal 22 may be mounted to a building wall, or integrated into an elevator door frame. Regardless of the particular arrangement of the floor terminal 22, at least parts of the elevator control network 26 and the communications line 24 extend in one embodiment in vertical direction within the elevator shaft 18. Since the elevator shaft 18 is used as a vertical conduit, installation of the technology described herein, e.g., when it is installed after the building 2 has been erected, is facilitated.

It is contemplated that the processing unit 6 recognizes the sensor unit 4 that generates an audio signal. In one embodiment, each sensor unit 4 stores a sensor identifier, and the processing unit 6 maintains a database storing for each sensor unit 4 a data set. Each data set stores the sensor unit's identifier together with information about where it is located within the building 2. For example, if the sensor unit 4 generates an audio signal, it transmits the sensor identifier together with the audio signal to the RF transceiver 20. In one embodiment, the RF transceiver 20 forwards the audio signal and the sensor identifier to the processing unit 6. The processing unit 6 may then identify the sensor unit 4 and/or its location, and the RF transceiver 20.

FIG. 2 shows a schematic illustration of an exemplary situation of a floor of the building 2 shown in FIG. 1. On that floor, the building 2 has a main entrance 40 and two side entrances 41 through which persons can enter and leave the building 2. Depending on a particular embodiment, the building 2 may have more or less entrances 40, 41. The main entrance 40 leads to a lobby 32, and the side entrances 41 lead to a lobby 34. Each lobby 32, 34 allows a person to access an elevator installation 1, an escalator installation 38, and a stairwell 43 to reach another floor of the building 2. Further, each lobby 32, 34 allows the person to walk into corridors and hallways 36 and individual rooms 45. Similar situations may exist on other floors as well. In the illustrated embodiment, the sensor units 4 are installed at various locations on the floor, e.g., in the hallways 36, at or near a door 30 or an entrance 40, 41, at or near an elevator installation 1, or in or near a staircase 43. The number of installed sensor units 4 and selecting the locations depends, e.g., on the size of the building 2, the use of the floor (e.g., as a ball room floor, a conference floor, or a restaurant floor).

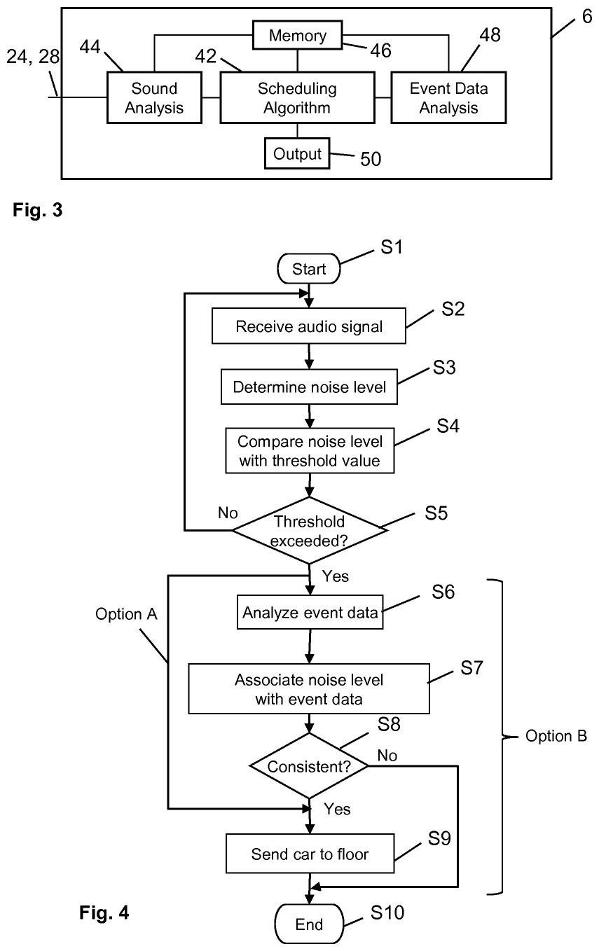

FIG. 3 shows a schematic illustration of the processing unit 6 of FIG. 1 to describe some of its functions. In the illustrated embodiment, the processing unit 6 includes a scheduling processor 42, a sound processor 44, a data processor 48, a memory device 46, and an output 50. The scheduling processor 42 is coupled to the sound processor 44, the data processor 48, the output 50, and the memory device 46, which is further coupled to the sound processor 44 and the data processor 48. The skilled person understands that the processing unit 6 is configured to receive via the communications lines 24, 28 as many (contemporaneous) audio signals as there are sensor units 4 in the building 2. It is contemplated that in one embodiment the analysis of the building event data, which is optional, may be omitted. Further, it is contemplated that FIG. 3 depicts the sound processor 44, the data processor 48, the memory device 46, and the scheduling processor 42 for illustrative purposes by means of functional blocks. In certain specific implementations, one or more functions represented by these functional blocks may be omitted and/or merged with another function. Also, in one embodiment, the processing unit 6 is a computer system that incorporates the sound processor 44, the data processor 48, the memory device 46, and the scheduling processor 42, or their functions.

The memory device 46 includes a readable storage media, which can comprise, for example, one or more of optical disks, volatile memory components (such as DRAM or SRAM), or nonvolatile memory components (such as hard drives, Flash RAM or ROM). In one embodiment, the memory device 46 maintains a database that stores for each sensor unit 4 installed in the building 2 a data set. Each data set includes the sensor unit's identifier together with information about where it is located within the building 2. The information of these data sets may be combined with information about the structural layout of the building 2, and represented, e.g., in a building plan and/or individual floor plans. The memory device 46 can be accessed at least by the scheduling processor 42 and the sound processor 44.

The sound processor 44 processes and analyzes in one embodiment each received audio signal. For example, the sound processor 44 analyzes the audio signal to determine the signal's noise-level information as a function of time, i.e., the sound processor 44 determines the volume of the noise in the sensor unit's vicinity, and detects, for example, if and when the volume increases. The sound processor 44 may further analyze the audio signal to determine an average noise level (e.g., a noise base level) over a predetermined period of time. For example, the sound processor 44 determines how loud it is on a floor L1, L2, L2 on average. The average noise level represents a threshold value used to determine an increased noise level. Contributing to the average noise are, e.g., background noise caused by machines (e.g., air conditioning equipment, cleaning machines, a vending machine), street traffic (e.g., noise entering through windows or doors), or construction taking place in the building 2. That background noise may vary during the course of a day, e.g., it may become lower during nighttime, higher during (street) traffic and office rush hours, and be somewhere in between during other times of the day. In one embodiment, the sound processor 44 uses a stored threshold value that represents an average noise level of talking persons. The threshold may be fixed for all floors L1, L2, L3, or determined by measurements on each floor L1, L2, L3. For each audio signal, the audio signal itself and/or the result of the processing and analysis may be stored in the storage device 46, and/or buffered for access by the sound processor 44.

In one embodiment of the processing unit 6, a machine learning algorithm is implemented that detects acoustic events. The machine learning algorithm may be executed by the sound processor 44, the scheduling processors 42, or a combination thereof. The implemented machine learning algorithm may be based on algorithms described in, for example, Shannon McKenna and David McLaren, “Acoustic Event Detection Using Machine Learning: Identifying Train Events” (printed on Nov. 23, 2016 from: http://cs229.stanford.edu/proj2012/McKennaMcLaren-AcousticEventDetectionUsingMachineLearningIdentifyingTrainEvents.pdf), or Andrey Temko, et al., “CLEAR Evaluation of Acoustic Event Detection and Classification Systems”, published in R. Stiefelhagen and J. Garofolo (Eds.): CLEAR 2006, LNCS 4122, pp. 311-322, Springer-Verlag, 2007. The machine learning algorithm of the processing unit 6 uses the received audio signals to determine for at least one of the floors L1, L2, L3 a noise pattern over a set period of time, e.g., a day, a week, a month, or a year. Such a noise pattern may be determined for each floor L1, L2, L3.

The processing unit 6 analyzes a noise pattern to learn when periods of a noise base level occur, and when periods of noise above the noise base level occur, if any. The learning may be assisted by event data obtained from the building event database 8. For example, in an office environment, the processing unit 6 may learn that every day between 18:00 and 19:00 the noise level increases by about 3 decibel (dB) above the noise base level due to cleaning, and between 11:30 and 13:00 by about 2 dB due to people collecting for lunch. The increased noise level during lunch time justifies sending an elevator car 10 to the concerned floor L1, L2, L3, whereas that during 18:00 and 19:00 would not. It is contemplated that the processing unit 6 in one embodiment continuously updates the one or more noise patterns. It, therefore, learns of and adapts to changes occurring in the building 2 over time.

As mentioned above, the processing unit 6 uses a threshold value to determine whether or not a current noise level is considered as an increased noise level. In one embodiment, more than one threshold values may be defined, for example, a first and a second threshold value. The second threshold value refers to a higher noise level than the first threshold value. For instance, the first threshold value may refer to the average noise caused by a first group of people, and the second threshold value to the average noise of a second group of people, whereas the second group includes more people. The processing unit 6, e.g., its scheduling processor 42, may be configured to send one elevator car 10 to the concerned floor L1, L2, L3 if the current noise level exceeds the first, but not the second threshold value, and, assuming the elevator installation 1 includes an elevator group, to send two elevator cars 10 if the current noise level exceeds the second threshold value.

Depending on a particular implementation of the processing unit 6, the sound processor 44 may subject the audio signal to a (digital) filtering process and/or a frequency analysis to determine the frequency spectrum of the audio signal. The frequency spectrum allows obtaining information as to the source, or sources, of the noise. That is, signal components distributed mainly in a frequency range of about 300 Hz to about 3000 Hz indicate the presence of voice, whereas noise caused by machines, e.g., during construction work, or street traffic is responsible for signal components distributed over a broader frequency range, including lower and/or higher frequencies. Analyzing the frequency spectrum, hence, facilitates distinguishing (or isolating) noise caused by voices from other noise and detecting a change (e.g., an increase) of the noise caused by voices. In one embodiment, the noise caused by sources other than voice may be disregarded.

Referring to the embodiment shown in FIG. 2 where multiple sensor units 4 are arranged on a floor L1, L2, L3. In that embodiment, the sound processor 44 receives multiple audio signals, and isolating noise caused by voice may be assisted by further analysis of the audio signals. In one embodiment, the sound processor 44 analyzes the audio signals to determine if the source of noise is approaching to distinguish it from noise which does not “move,” such as background noise or impulse noise from construction, street traffic and/or machines. Assuming, for example, a group of people leaves a conference room (individual room 45 in FIG. 2), one or more sensor units 4 in the vicinity detect an increased noise level. For one or more of the audio signals, the sound processor 44 may, for example, analyze a frequency shift caused by the Doppler effect to detect if the noise is approaching the respective sensor unit 4 from a certain direction. For example, a sensor unit 4 may detect an approaching noise (frequency shift to higher frequencies), while a neighboring sensor unit 4 may detect noise that moves away (frequency shift to lower frequencies).

In the situation of FIG. 2, the sound processor 44 may in one embodiment analyze the audio signals to determine how the noise caused by the group of people propagates on the floor. For example, the sound processor 44 may identify the sensor unit 4 that detected the increased noise level first, the sensor unit 4 that detected the increased noise level next, and so on. In FIG. 2, for example, if the group leaves the conference room (45), the sensor unit 4 right in front of the conference room would detect the noise first, subsequently those that are arranged in the hallway leading to the lobby 34, and finally the sensor unit 4 in front to the elevator installation 1 that is next to the entrance 41. In this manner, the sound processor 44 may track the noise on the floor.

The data processor 48 is coupled to the building event database 8 (FIG. 1) and configured to analyze stored data regarding events scheduled to take place in the building 2, as s. Such events include, for example, dates for conferences, meetings, arrivals of groups (e.g., tourists in the case of a hotel), and/or other activities (e.g., building constructions, routine cleaning, routine restaurant operation) together with starting and end times, and floor/room information. For example, for a conference, the data includes the time it begins and when it ends, the floor, and the room number, or for the arrival of a tourist group, the data includes the expected arrival time at the hotel's lobby or reception. Using a computer user interface, for example, a building manager may enter such building event data and store it in the building event database 8 storage device 46. The data processor 48 analyzes the building event data, e.g., continuously, and signals when and where increased noise is to be expected.

The scheduling processor 42 executes a scheduling algorithm for the elevator car 10. The scheduling algorithm uses the audio signals themselves, the results of their processing, or both as input information. For example, the scheduling algorithm monitors the results of the audio signal processing and reacts upon a result that indicates an increased noise level on a floor L1, L2, L3. As a reaction, the scheduling algorithm generates a control signal that is fed to the elevator controller 12. The control signal identifies the floor L1, L2, L3 where the increased noise level exists, so that the elevator controller 12 may send the elevator car 10 to the floor L1, L2, L3.

In one embodiment, the scheduling processor 42 delays generating the control signal for the elevator for a predetermined period of time. The period of time is selected to avoid that a transient or impulse noise triggers the sending of an elevator car 10 to the floor L1, L2, L3. Transient or impulse noise may be caused, for example, by construction work. The period of time signifies that any increased noise level must last for a certain time before an elevator car 10 is called to a floor L1, L2, L3. For example, the period of time is in the range of a few seconds.

Optionally, the scheduling algorithm may use the building event data as additional input information. If it is available, the building event data may indicate that a conference is taking place, or that construction is going on in the building 2. The scheduling algorithm associates any increased noise level on a floor L1, L2, L3 with the building event data to verify if the occurrence of increased noise is consistent with the building event data. For example, if an increased noise level is detected on a floor L1, L2, L3 while the building event data indicates that a conference room is occupied on that floor L1, L2, L3, the noise level is consistent with the event data, and sending an elevator car 10 to the floor L1, L2, L3 is justified. However, if an increased noise level is detected on a floor L1, L2, L3 while no conference room is occupied on that floor L1, L2, L3, the noise level is not consistent with the event data, and no elevator car 10 would be called.

With the understanding of the general structure and function of the elevator installation 1 and certain features of its components described with reference to FIG. 1, FIG. 2 and FIG. 3, a description of how one embodiment of the elevator installation 1 operates follows with reference to FIG. 4. FIG. 4 shows a flow diagram of one embodiment of a method of controlling the elevator installation 1. It is contemplated that in another illustration of the flow diagram some of the shown steps may be merged into a single step, or split into several separate steps. The flow diagram starts at a step Si and ends at a step S10.

In a step S2, at least one audio signal generated by a sensor unit 4 is received by the processing unit 6. In an embodiment according to FIG. 1 or FIG. 2, the processing unit 6 receives several audio signals, one from each sensor unit 4. Each audio signal may vary over time depending on the noise level on a floor L1, L2, L3.

Proceeding to a step S3, the noise level of each audio signal is determined. The determination is made by the processing unit 6, e.g., its sound processor 44. For example, the processing unit 6 extracts volume information from the audio signal, and identifies the sensor unit 4 that generated the audio signal. The identity of the sensor unit 4 may be extracted from the audio signal. The processing unit 6 stores the obtained volume and identity information, e.g., in the storage device 46.

Proceeding to a step S4, the noise level is compared with a threshold value. The threshold value is determined, as described above, and stored in the processing unit 6, e.g., in the storage device 46. The processing unit 6 uses the obtained volume information to compare it with the threshold value. If the processing unit 6 determines in a step S5 that the threshold value is exceeded, the method proceeds along the Yes branch, either to a step S9 (according to an option A), or to a step S6 (according to an option B). If the threshold value is not exceeded, the method returns to the step S2.

If the method proceeds according to option A to the step S9, the processing unit 6 generates a control signal for the elevator controller 12. The control signal includes an indication of the floor L1, L2, L3 where the increased noise level was detected, i.e., where elevator service is likely to be required. In response to the control signal, the elevator controller 12 causes an elevator car 10, for example, to move to the concerned floor L1, L2, L3. At that time, and depending on a current situation of the elevator installation 1, the elevator controller 12 may prevent an elevator car 10 that is already on the concerned floor L1, L2, L3 from leaving, send an elevator car 10 that is waiting on another floor L1, L2, L3 to the concerned floor L1, L2, L3, or schedule (or reserve) an elevator car 10, which is currently servicing a call and transporting passengers, to move to the concerned floor L1, L2, L3 once the current service has been completed.

Once the elevator controller 12 processed the control signal, the method ends in the step S10. It is contemplated that the elevator controller 12 may then receive a call entered at the concerned floor L1, L2, L3. Such a call may be entered using the floor call terminal 16 (e.g., the call may be a destination call), or using a COP inside the elevator car 10.

If the method proceeds according to option B to the step S6, building event data is analyzed. In that embodiment, the processing unit 6 obtains building event data from the building event database 8, and determines if, for a time window around the time of the increased noise level, a building event is recorded. For example, the building event data may include time and location information for each event, or indicate that none is recorded for the concerned time window.

Proceeding to a step S7, the noise level is associated with the building event data. The processing unit 6 determines, in a step S8, if the occurrence of the increased noise level is consistent with the building event data, as described above. If the occurrence is not consistent, the method proceeds along the No branch to the step S10 and ends there. However, if the occurrence is consistent, the method proceeds along the Yes branch to the step S9. In the step S9, the processing unit 6 generates a control signal for the elevator controller 12, and causes an elevator car 10 to move to the concerned floor L1, L2, L3, as described above.

1. An elevator installation for a building, comprising:
an elevator controller to control an elevator car to move from one floor to another floor of the building;
a plurality of sensor units, each sensor unit located on a respective floor and configured to generate an electrical signal that is indicative of a noise level in its vicinity on the respective floor; and
a processing unit coupled to the elevator controller and the sensor units,
wherein the processing unit is configured to receive and analyze electrical signals from the sensor units to determine if an electrical signal indicates an increased noise level on the respective floor on which the sensor unit generating that electrical signal is located, and to generate a control signal for the elevator controller that is indicative of the respective floor with the increased noise level, wherein analyzing an electrical signal includes:
analyzing a frequency shift caused by a Doppler effect to determine if a source of noise approaches the respective sensor unit, or
determining a sequence of sensor units that sequentially detect increased noise levels on respective floors to determine a direction of movement of the source of noise, and
wherein the elevator controller in response to the control signal causes the elevator car to move to the floor with the increased noise level.

2. The elevator installation of claim 1, wherein each sensor unit includes an electroacoustic transducer, wherein the electroacoustic transducer converts air pressure changes caused by noise or voices into the electrical signal.

3. The elevator installation of claim 1, wherein each sensor unit includes a radio frequency module for transmitting the electrical signal.

4. The elevator installation of claim 3, further comprising a plurality of radio frequency transceivers coupled to the processing unit, wherein each radio frequency transceiver is configured to receive the electrical signal transmitted by any radio frequency transmitter that is located within radio frequency range.

5. The elevator installation of claim 1, further comprising a communications network comprising communications lines, wherein each sensor unit is coupled to the processing unit via at least one of the communications lines.

6. The elevator installation of claim 1, further comprising a database coupled to the processing unit, wherein the database stores data relating to building events.

7. The elevator installation of claim 1, wherein the processing unit includes a scheduling processor, a sound processor, a data processor, and a memory device, wherein the scheduling processor is coupled to the sound processor, the data processor, and the memory device, which is further coupled to the sound processor and the data processor.

8. The elevator installation of claim 1, wherein the processing unit is configured to execute a machine learning algorithm to analyze the electrical signals to determine for at least one of the floors of the building a noise pattern over a set period of time.

9. A method of controlling an elevator installation in a building having a plurality of floors, wherein the elevator installation includes an elevator controller that causes an elevator car to move from one floor to another floor, a plurality of sensor units each located on a respective floor the floors, and a processing unit coupled to the elevator controller and the sensor units, the method comprising:
receiving, by the processing unit, electrical signals from the sensor units, wherein each electrical signal is indicative of a noise level on a respective floor in a vicinity of the sensor unit that generates the electrical signal;
analyzing, by the processing unit, the electrical signals to determine if one of the electrical signals is indicative of an increased noise level on the respective floor on which the sensor unit generating that electrical signal is located, and, if such an electrical signal is determined, generating a control signal for the elevator controller that is indicative of the respective floor with the increased noise level, wherein analyzing an electrical signal includes:
analyzing a frequency shift caused by the a Doppler effect to determine if a source of noise approaches the respective sensor unit, or
determining a sequence of sensor units that sequentially detect increased noise levels on respective floors to determine a direction of movement of the source of noise; and
causing, by the elevator controller, the elevator car to move to the floor with the increased noise level in response to the control signal.

10. The method of claim 9, wherein determining if one of the electrical signals is indicative of an increased noise level includes for each electrical signal comparing the noise level represented by the electrical signal with a threshold value, wherein exceeding the threshold value indicates an increased noise level on the respective floor.

11. The method of claim 10, wherein the threshold value represents a base noise level prevalent on a floor.

12. The method of claim 11, wherein the base noise level is a function of time.

13. The method of claim 10, wherein the threshold value represents an average noise level caused by talking persons.

14. The method of claim 10, wherein determining if one of the electrical signals is indicative of an increased noise level includes for each electrical signal comparing the noise level represented by the electrical signal with a further threshold value, wherein the further threshold value is higher than the threshold value, wherein the elevator installation includes more than one elevator car wherein exceeding the further threshold value indicates an increased noise level on the respective floor, and wherein in response to an exceeded further threshold value two elevator cars are caused to move to the floor with the increased noise level.

15. The method of claim 9, wherein the control signal for the elevator controller is generated when a predetermined period of time expires.

16. The method of claim 9, wherein analyzing the electrical signals includes executing a machine learning algorithm to analyze the electrical signals to determine for at least one of the floors a noise pattern over a set period of time.
